(19) United States
(12) Patent Application Publication
(10) Pub. No.: US 2006/0235703 A1
(43) Pub. Date: Oct. 19, 2006

(54) Electronic transmission of documents

(76) Inventors: Jan Wendenburg, Dusseldorf (DE); Percy Dahm, Castrop Rauxel (DE)

Correspondence Address: GLENN E. KLEPAC, 825 FIFTH AVE., SUITE 209, NEW KENSINTON, PA, 15068-6310, US

(21) Appl. No.: 10/549,163

(22) PCT Filed: Mar. 15, 2004
(86) PCT No.: PCT/EP04/02653

§ 371 Date: May 22, 2006

(30) Foreign Application Priority Data
Mar. 14, 2003 (DE) 103 11 634.6

(51) Int. Cl. G06Q 99/00

(52) U.S. Cl. 705/1

(57) ABSTRACT

As a method which allows the most efficient possible exchange of electronic data and documents of a sender with multiple receivers, a method for the electronic transmission of data of at least one document from a sender to a receiver, particularly for the transmission of invoices, is suggested, in which a) the data is provided with an electronic signature before being sent by the sender, b) before the release of the data for transmission to the receiver, a validity test is performed on the electronic signature, in which at least the certificate of the electronic signature is checked for its validity, and c) the data is released for transmission to the receiver together with the electronic signature and a test log of the signature test.

The present invention relates to a method for transmitting signed data and/or documents.

Many fields of economics and administration are currently attempting to convert paper-based document processing and administration exclusively to digital data processing, since documents and data may be archived and reproduced digitally significantly more easily. In order to avoid media breakdown in the processing of documents in this case, great efforts are being made to exchange documents electronically not only within an enterprise, but rather also between enterprises. An essential problem in the exchange of digital data and documents in commerce is the legally binding force of this data and/or these documents. It is thus not possible without something further to ensure who sent specific data or documents or whether the data has been changed after the sending.

There are various approaches for authenticating data and documents via digital signatures. The EU signature guidelines and, in Germany, the signature law (SigG) and the signature code (SigV) were enacted in this context. The signature law essentially distinguishes between three appearance forms of electronic signatures, specifically simple, advanced, and qualified electronic signatures, the security from forgery of the electronic signatures being low with a simple signature and being comparatively high with a qualified electronic signature. The security from forgery of qualified signatures may still be increased through a supplier accreditation, which means that the issuer of the key pair and the certificate for the electronic signature fulfills special security criteria.

Depending on the type of the data or the document, different requirements are placed on the security of the electronic signature, so that it unfolds legal effect after electronic transmission.

A special problem is, for example, the tax relevance of electronically transmitted invoices. Thus, according to the VAT law currently applicable in Germany, a VAT listed in an invoice may only be claimed for tax purposes by the invoice receiver if the digital invoice has been provided with a qualified electronic signature. This represents a significant problem in relation to invoices sent in paper form in particular, if an enterprise sends multiple invoices to multiple receivers. Even in comparatively closed user groups, such as the users of the EDIFACT system (Electronic Data Interchange Faktura), via which order data, bills of delivery, and invoice data may be exchanged in the framework of a complex data model between enterprises, digital signatures are not used. In order to achieve the object of recognition under tax law of electronic invoices transmitted via EDIFACT, they have gone over to printing all digitally sent individual invoices summarized in a collective invoice as a paper document at the end of a specific period of time, for example, at the end of a month, and then sending the collective invoice to the invoice receiver. A significant disadvantage of this method is that the collective invoice must be compared by the receiver to the individual electronically sent invoices. This procedure is therefore complex and not cost-effective.

A further set of problems in sending electronic data, particularly invoices, is that in accordance with the principles for verifiability of digital documents (GDPDU), a verification mechanism is necessary, via which it is possible for the receiver to check the validity of the digital signature. Although it is not currently a legal requirement that the electronic signatures be checked for their validity, it is in the interest of every receiver to be able to fall back on corresponding evidence of validity in order to be able to furnish evidence for the validity of the signature at the time of its issuance in case of dispute.

With this background, the present invention is based on the object of providing a method of the type cited at the beginning which allows the most efficient possible exchange of electronic data and documents of a sender with multiple receivers.

This object is achieved by a method for electronic transmission of data of at least one document from a sender to a receiver, particularly for transmitting invoices, in which
a) the data is provided with an electronic signature before being sent by the sender,
b) before the release of the data for transmission to the receiver, a validity test is performed on the electronic signature, in which at least the certificate of the electronic signature is checked for its validity, and
c) the data is released for transmission to the receiver together with the electronic signature and a test log of the signature test.

Using this method, it is possible for the sender to provide all information electronically to the receiver which is necessary in order to be able to prove the authenticity and the legally binding force of the transmitted data in relation to the sender or a third party. The receiver only has to archive the data in order to be able to furnish such proof even a long time after receiving the data.

Since this system is independent of the type of data to be transmitted, no complex hardware or software installations must be set up by the receiver in order to be able to participate in an electronic exchange of invoices. In particular, an infrastructure for checking electronic signatures and/or their certificates, which is typically extremely complex because of the multiple different signature suppliers, may be dispensed with. Since the acceptance of electronic invoices by receivers may thus be significantly increased, it becomes simpler for the sender to convert his entire invoice system to a purely digital mode of operation or at least to reduce to a minimum the quantity of invoices or other documents to be printed on paper and sent by mail, through which the document preparation costs and the sending costs may be significantly reduced.

The method according to the present invention may be incorporated without anything further in existing overall solutions for electronic invoice preparation, such as the EDIFACT system.

In a preferred embodiment of the method according to the present invention, the data and/or the electronic signature is provided with a first time stamp, particularly a first qualified time stamp.

A time stamp is understood here and in the following as a signature key which results from the coding of a test cipher code which identifies the data to be provided with the time stamp, and a statement of time at the instant of producing the time stamp using a private key of an asynchronous coding method, and to which the test cipher code and the statement of time are attached. A time stamp is qualified when it is produced by a service supplier who is specially accredited for this purpose, such as a trust center.

Through the use of time stamps, it is possible to prove that a specific data set already existed in unchanged form at the instant of producing a time stamp, by decoding the time stamp using a public-key and comparing the test cipher code obtained with a test cipher code for the existing data set. If both test cipher codes are identical, the present data set is also identical to the data set for which the time stamp was produced.

If a time stamp for the data and/or the electronic signature is produced accordingly, it may be determined at a later instant whether or not the data provided at this instant is unchanged in comparison to the original data. In particular, it may thus also be proven that the certificate which the signature is based on was still valid at the instant of the signature preparation.

In a further preferred embodiment of the method according to the present invention, the test log is provided with a second time stamp, particularly a second qualified time stamp. Using this second time stamp it is possible to furnish proof that the test log existed in unchanged form at the instant of producing the second signature and also, in particular, that the certificate which the second signature is based on was valid at the instant of the signature preparation.

If the second time stamp additionally images all data to be transmitted, under some circumstances a first time stamp for proof of identity of documents may be dispensed with.

In order that the proof that the test log has also been actually tested by a location authorized for this purpose may be furnished, the test log is preferably provided with an electronic signature of the instance testing the validity of the electronic signature. This is particularly advantageous if the receiver of the data is not an active participant in the testing of its legally binding force, but merely receives the test log.

In another preferred embodiment of the method according to the present invention, the data to be transmitted is possibly transmitted together with the electronic signature to an ASP server, the ASP server checking the validity of the electronic signature and the data packet, comprising data, electronic signature, and test log, being provided to the receiver. The term ASP server stands for “application service provider” and is a server which provides software services for third parties either in the enterprise itself or in the Internet.

It is possible in principle that the ASP server also assumes the task of providing the data to be transmitted with a signature identifying the sender, if the sender provides the ASP server operator with the appropriate identification information. In addition, it is possible that the ASP server also offers archiving services for sender and receiver.

The data released for the receiver, i.e., particularly the data to be transmitted, including the signature of the sender and the test log and possibly first and second time stamps and further signatures, may then be provided to the receiver on a server so it may be called up as needed, so that the receiver may call up the data specific to him from this server via the Internet, for example. As an alternative or supplement thereto, the data to be transmitted to the receiver may also be transmitted directly by e-mail or other electronic data transmission pathways. For both transmission variations, it is advantageous if the data to be transmitted is transmitted encrypted, so that third parties may not see the data without something further.

In the following, the present invention will be explained in greater detail for a preferred exemplary embodiment of the method on the basis of a sequence diagram which explains the method.

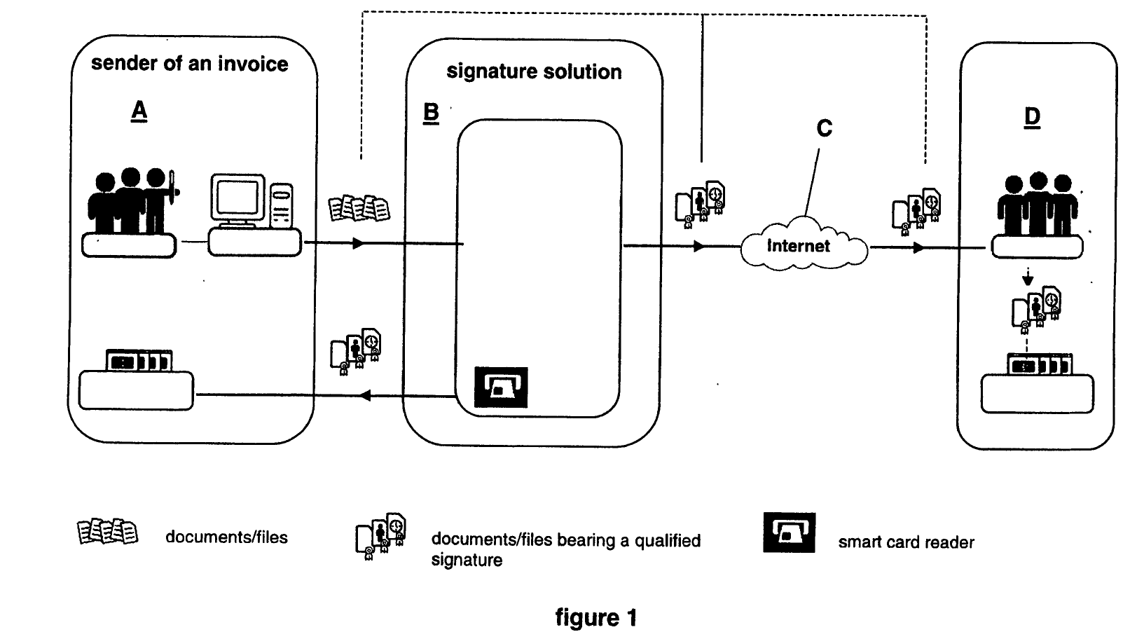

FIG. 1 shows a schematic diagram of the local assignment of the work steps of the method, and

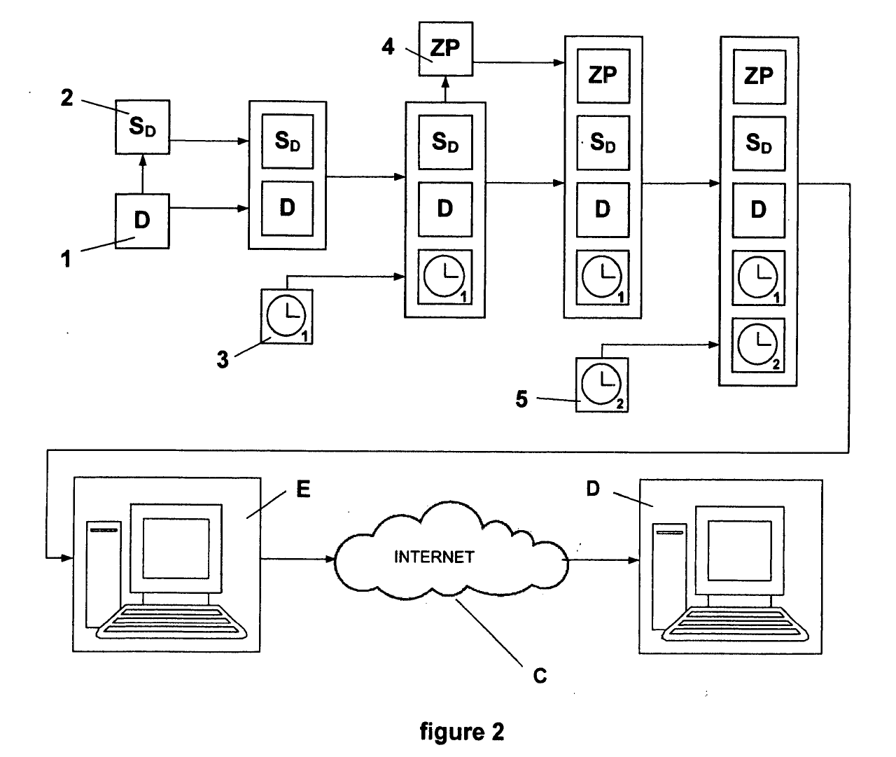

FIG. 2 shows a sequence diagram for the data processing.

FIG. 1 shows a diagram of how documents prepared in an enterprise A may be relayed to a signature service server B, provided there with required signatures and test logs, and transmitted together with the signatures and test logs to the document archive of the sending enterprise A and, via the Internet C, to a receiver D. In this case, the signature service server may either be a component of the electronic data processing system of the enterprise A, or it may also be an ASP server connected via a network (Internet) to the enterprise A and possibly to the receiver D. In the signature service server, as shown in FIG. 2, the data 1 is provided with an electronic signature 2 and a time stamp 3. The electronic signature 2 is prepared automatically, the signature 2 being able to receive, in addition to a certificate identifying the sender, an attribution certificate, using which the extent of the representation authorization of the electronic signing parties may be specified. The time stamp 3 advisably identifies both the data 1 to be transmitted and also the electronic signature 2, so that in particular proof may be furnished later at which instant the data 1 was latest signed.

In addition, the signature service server performs a signature test in such a way that it tests the certificate contained in the signature for its validity. For this purpose, the signature server may contain its own certificate administrator, whose data status is compared regularly with the data of one or various certification servers. However, the certificate to be checked is preferably transmitted by the signature server to the certification server which issues the certificate for the validity check. The test log 4 obtained using the test is attached to the data 1 to be transmitted, as are the electronic signature 2 and the time stamp 3. In order to obtain proof of which instance has performed the certificate test, the test log 4 may also be provided with an electronic signature by the issuing instance.

In the signature service server, a second time stamp 5 is then attached to the data to be transmitted, including the signature and the possibly signed test log 4, the time stamp 5 itself being produced either by the signature service server or by an external time stamp service.

Only then is the data to be transmitted released to the receiver. With the release, the data to be transmitted may be sent to the receiver by e-mail, for example, and alternatively or additionally provided to the receiver via a Web portal E.

1. A method for the electronic transmission of data of at least one document from a sender to a receiver, particularly for the transmission of invoices, wherein
a) the data is provided with an electronic signature before being sent by the sender,
b) before the release of the data for transmission to the receiver, a validity test is performed on the electronic signature, in which at least the certificate of the electronic signature is checked for its validity, and
c) the data is released for transmission to the receiver together with the electronic signature and a test log of the signature test.

2. The method according to claim 1, characterized in that the data and/or the electronic signature is/are provided with a first time stamp, particularly a first qualified time stamp.

3. The method according to claim 1 or 2, characterized in that the test log is provided with a second time stamp, particularly a second qualified time stamp.

4. The method according to claim 3, characterized in that the second time stamp images all data to be transmitted.

5. The method according to one of claims 1 through 4, characterized in that the test log is provided with an electronic signature of the instance testing the validity of the electronic signature.

6. The method according to one of claims 1 through 5, characterized in that an ASP server checks the validity of the electronic signature and provides the data packet comprising data, electronic signature, and test log to the receiver.

7. The method according to claim 6, characterized in that the data to be transmitted is provided, by the ASP server, with a signature identifying the sender.

8. The method according to one of claims 1 through 7, characterized in that the data, including all signatures and time stamps, is provided to the receiver electronically, particularly via a Web portal in the Internet, to be called up.

9. The method according to one of claims 1 through 8, characterized in that the data, including all signatures and time stamps, is transmitted to the receiver electronically, particularly by e-mail via the Internet.

10. The method according to one of claims 1 through 9, characterized in that at least a part of the data to be transmitted is encrypted.
